(19) United States
(12) Patent Application Publication
(10) Pub. No.: US 2012/0321102 A1
(43) Pub. Date: Dec. 20, 2012

(54) METHOD AND APPARATUS CREATING A PERSONAL SOUND ZONE

(75) Inventors: Hyung Joon LIM, Seoul (KR); Young Tee Kim, Seongnam-si (KR); Jordan Cheer, Southampton (GB); Steve Elliott, Southampton (GB)

(73) Assignee: SAMSUNG ELECTRONICS CO., LTD., Suwon-si (KR)

(21) Appl. No.: 13/334,203

(22) Filed: Dec. 22, 2011

(30) Foreign Application Priority Data
Dec. 22, 2010 (KR) 10-2010-0132090
Nov. 16, 2011 (KR) 10-2011-0119502

(51) Int. Cl. H04R 1/40

(52) U.S. Cl. 381/97

(57) ABSTRACT

A personal sound zone creating apparatus includes a broadside array adapted to generate a sound beam orthogonal to an arrangement of an array constituted by at least three transducers in a personal audio device. Therefore, the personal sound zone creating apparatus controls rear radiation by including an end-fire array increased in directivity in a horizontal direction.

### CROSS-REFERENCE TO RELATED APPLICATIONS

This application claims the benefit of Korean Patent Application No. 10-2010-0132090 and of Korean Patent Application No. 10-2011-0119502, respectively filed on Dec. 22, 2010 and Nov. 16, 2011, in the Korean Intellectual Property Office, the disclosures of which are incorporated herein by reference.

### BACKGROUND

1. Field

One or more embodiments of the following description relate to a method and apparatus creating a personal sound zone.

2. Description of the Related Art

A technology for creating a personal sound zone may enable delivery of a sound to only a designated listener without dedicated devices such as an earphone or a headset, and without inducing noise to others around the listener. Directivity of a sound generated by driving a plurality of sound transducers may be used to create the personal sound zone.

However, when sending a sound to, or collecting a sound from, a specific zone such as the personal sound zone through arrays of the sound transducers, the sound may also be dispersed to other zones, e.g., in low frequency bands. Especially in a small personal electronic device, such as a mobile device, creation of the personal sound zone is more difficult because of a limited array size and a limited number of installable transducers, as explained further below.

### SUMMARY

One or more embodiments provide an apparatus creating a personal sound zone, the apparatus including an array unit configured to include at least three transducers arranged orthogonal to a sound beam generation direction, the at least three transducers including at least one a respective port arranged in a direction away from the sound beam generation direction, and a control signal generation unit configured to generate control signals, including opposing phases, related to the array unit so that the array unit forms a sound beam, with sound directivity in a set direction toward a listener, in the sound beam generation direction.

Each of the at least three transducers may include a phase-shift driver mounted in-line with the sound beam generation direction and may be configured to generate the sound directivity in the direction toward the listener using a method of minimizing rear radiation occurring from each of the at least three transducers by generating an acoustic resistance in a direction different from the sound beam generation direction.

The control signal generation unit may further include an equalizer configured to compensate for sound volume variation and frequency response according to different frequencies, caused by irregular responses of the respective phase-shift drivers, and to compensate for differences in phases and gains respectively among the at least three transducers.

Intervals among the at least three transducers may be in-line and uniform.

The control signal generation unit may generate control signals such that a control signal related to a middle transducer among the at least three transducers has a different gain from control signals related to side transducers respectively disposed on a left side and a right side of the middle transducers.

The control signal generation unit may control signals such that control signals related to side transducers respectively disposed on the left side and the right side of a middle transducer among the at least three transducers have a same gain and a same phase as each other.

The sound directivity may be provided in the direction toward the listener based on a set distance r in a set direction of an angle θ, relative to a center line of the array that is orthogonal to the array.

In addition, the apparatus may be a personal audio electronic device including at least one processing device.

One or more embodiments include a method of creating a personal sound zone, the method including generating a sound beam, with sound directivity in a set direction toward a listener, orthogonal to an arrangement of at least three transducers of an array, to form the personal sound zone in a sound beam generation direction, and applying control signals to the at least three transducers included in the array so that adjacent transducers are applied control signals having opposing phases.

The at least three transducers may include at least one respective port arranged in a direction away from the sound beam generation direction, and the method may further include minimizing rear radiation through the at least one respective port corresponding to the generated sound beam based on the applied control signals having the opposing phases.

Each of the at least three transducers may include a phase-shift driver that is mounted in-line with the sound beam generation direction and configured to generate the directivity in the direction toward the listener using a method of minimizing rear radiation occurring from each of the at least three transducers by generating an acoustic resistance from each of the at least three transducers in a direction different from the sound beam generation direction.

The method may further compensate for sound volume variation and a frequency response according to different frequencies, caused by irregular responses of the respective phase shift drivers, and also compensate for differences in phases and gains among the at least three transducers.

The method may further include arranging the at least three transducers at uniform in-line intervals in the array.

The method may further include controlling the control signals such that a control signal related to a middle transducer disposed in the middle among the at least three transducers has a different gain from control signals related to side transducers respectively disposed on a left side and a right side of the middle transducer.

The method may further include controlling the control signals such that control signals related to side transducers respectively disposed on the left side and the right side of a middle transducer disposed in the middle among the at least three transducers having same gain and a same phase as each other.

The sound directivity may be provided in the direction toward the listener based on a set distance r in a set direction of an angle θ, relative to a center line of the array that is orthogonal to the array.

One or more embodiments includes an apparatus creating a personal sound zone, the apparatus including an array unit configured to include at least three transducers, and an amplifying element configured to provide control signals to the array unit so that adjacent transducers are applied control signals having opposing phases to minimize rear radiation by the transducers and so that the array unit forms a sound beam in the sound beam generation direction with directivity in a set direction toward a listener.

The sound beam generation direction may be orthogonal relative to an arrangement of the at least three transducers in the array unit and the sound directivity may be provided in the set direction toward the listener based on a set distance r in a set direction of an angle θ, relative to a center line of the array that is orthogonal to the array.

Each of the at least three transducers may include a phase-shift driver mounted in-line with the sound beam generation direction that are configured to generate the directivity in the set direction of the listener, and minimize the rear radiation by providing an acoustic resistance to one or more of the transducers in a direction different from the sound beam generation direction.

The acoustic resistance may be metal gauze.

The apparatus may further include a control signal generation unit, including the amplifying element and an equalizer, the equalizer being configured to compensate for sound volume variation and frequency response according to different frequencies, caused by irregular responses of the respective phase-shift drivers, and to compensate for differences in phases and gains respectively among the at least three transducers.

The amplifying element may provide the control signals such that a control signal related to a middle transducer among the at least three transducers has a different gain from control signals related to side transducers respectively disposed on a left side and a right side of the middle transducers.

The apparatus may be a personal audio electronic device including at least one processing device.

Additional aspects, features, and/or advantages of one or more embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the one or more embodiments, taken in conjunction with the accompanying drawings of which:

FIG. 1 illustrates a personal sound zone creating apparatus, according to one or more embodiments;

FIGS. 2 and 3 illustrate a coordinate system between an array and a listener, according to one or more embodiments;

FIG. 4 illustrates a result of comparing beam widths per aperture size of an array being uniformly excited, according to one or more embodiments;

FIG. 5 illustrates a method of solving a problem of a broadside sound source array, according to one or more embodiments;

FIG. 6 illustrates variations of a broadside beam pattern according to variation of a parameter, according to one or more embodiments;

FIG. 7 illustrates a physical structure of a phase-shift loudspeaker, according to one or more embodiments;

FIG. 8 illustrates an equivalent circuit model of the phase-shift loudspeaker, according to one or more embodiments;

FIG. 9 illustrates a method for solving a problem related to arrangement of a first order end-fire sound source, according to one or more embodiments;

FIG. 10 illustrates a beam pattern with respect to a parameter (μ) in the first order end-fire, according to one or more embodiments;

FIG. 11 illustrates a beam pattern generated by a personal sound zone creating method, according to one or more embodiments;

FIG. 12 illustrates a method of creating a personal sound zone, according to one or more embodiments;

FIG. 13 illustrates an array, according to one or more embodiments;

FIG. 14 illustrates a personal electronic audio device, according to one or more embodiments; and

FIG. 15 illustrates signal processing procedures in a personal sound zone creating apparatus, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

Conventional limits in creating a personal sound zone in a small personal audio electronic device, such as a mobile device, are introduced as follows.

First, conventionally, a beam width is limited. A size of a sound zone generated by such an array using a sound transducer increases in proportion to a wavelength. Therefore, the corresponding sound zone increases in sizes in the low frequency bands where a wavelength is similar to or greater than an aperture size of an array. Accordingly, such a beam width with respect to the sound zone becomes physically uncontrollable.

Second, conventionally, a number of integrated sound transducers constituting an array is limited. Corresponding small personal audio electronic devices, such as mobile devices, the number of the sound transducers is limited. However, when the personal audio electronic devices are designed to be small and the number of the sound transducers is also small, the generated sound pressure may not be sufficiently amplified by overlapping sound waves.

Third, conventionally, control of rear radiation is limited. When such sound beams are generated orthogonal to arrays in a linear array unit, a backward sound beam is generated symmetrically to the forward sound beam as the sound wave is diffracted backward. Since diffraction occurs more easily in small devices, the backward sound beam may have a size relatively equal to the forward sound beam.

Therefore, one or more embodiments provide an apparatus, system, and method, creating one or more personal sound zones, which are capable of controlling sound beams even with a small transducer array having a relatively small number of sound transducers while minimizing rear radiation sound.

In addition, one or more embodiments provide an apparatus, system, and method creating one or more personal sound zones, capable of securing a sufficient sound pressure difference in an overall or wide frequency band, and focusing a sound even when an array size is extremely small when compared to desired wavelength.

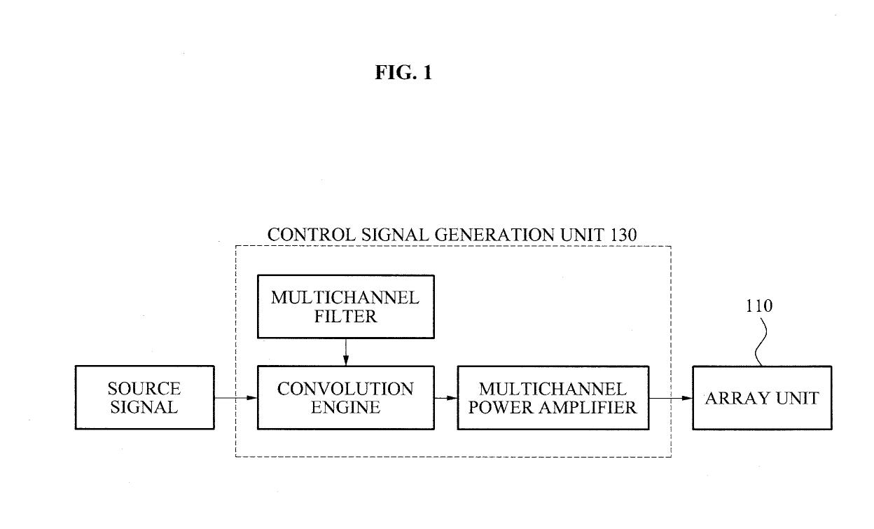

FIG. 1 illustrates a personal sound zone creating apparatus 100, according to one or more embodiments. Referring to FIG. 1, the personal sound zone creating apparatus 100 may include an array unit 110 and a control signal generation unit 130, for example.

The array unit 110 may include at least three transducers arranged orthogonal, for example, to a sound beam generation direction in a forward direction, e.g., in a direction of a listener. Hereinafter, the transducer will refer to a sound transducer, which may include a speaker, depending on embodiment. In addition, though embodiments may be described with orthogonally arranged arrays, e.g., relative to the desired output direction of the sound, embodiments are not limited thereto.

Each of the at least three transducers may include an open port or a cavity directed in a rearward direction, relative to the respective transducer and the forward direction.

Each of the at least three transducers may be a phase-shift driver mounted toward the listener and configured to generate set directivity in the direction toward the listener using a method of reducing rear radiation occurring from each of the at least three transducers by generating an acoustic resistance in a rearward direction.

The acoustic resistance may be formed by attaching a sheet of metal gauze in the rearward direction from the transducer, that is, in the direction of the open port. For example, presuming that a surface A of the transducer denotes a surface in the forward direction, e.g., toward the listener, and a surface B denotes a surface in the rearward direction, the surface B may form the acoustic resistance using the sheet of metal gauze.

In the array unit 110, intervals among the at least three transducers may be uniform.

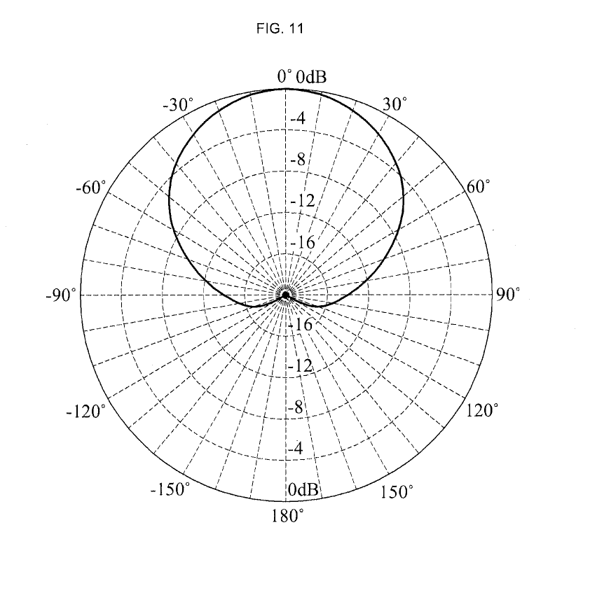

Arrangement of an array including the at least three transducers in the array unit 110 will be described below with reference to FIG. 11.

The control signal generation unit 130 may generate control signals related to the array unit 110 so that the array unit 110 may generate a sound beam orthogonal, for example, to an arrangement direction of the at least three transducers.

The control signal generation unit 130 may generate the control signals such that a control signal, related to a middle transducer disposed in the middle among the at least three transducers, has a different gain from control signals related to side transducers disposed on the left side and the right side of the middle transducers.

The control signal generation unit 130 may control the control signals such that control signals related to the side transducers disposed on the left side and the right side of the middle transducer have the same gain and the same phase.

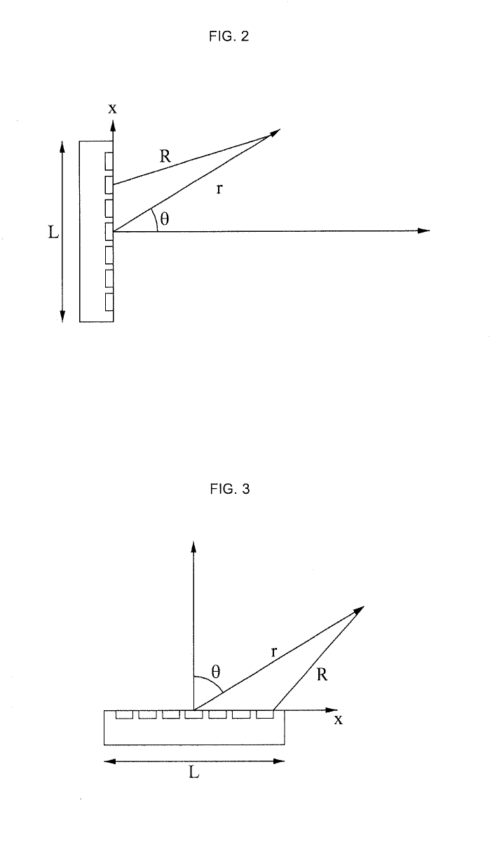

FIGS. 2 and 3 illustrate a coordinate system between an array and a listener, according to one or more embodiments.

FIG. 2 shows a coordinate system between the listener and a broadside array having a delay and sum structure.

Referring to FIG. 2, it is presumed that the listener is positioned away from a center of the array by an example set distance r in a direction of an example set angle θ. A symbol R denotes a distance between the listener and a transducer disposed at a distance x from the center of the array.

The distance R between the listener and the transducer may be calculated according to the below Equation 1, as only an example.

R=\sqrt{r²+x²−2xr sin θ}≈r−x sin θ Equation 1

Here, r denotes the distance from the center of the array to the listener, θ denotes the angle of a position of the listener relative to the center of the array, and x denotes the distance from the center of the array to the transducer.

A sound pressure P(r, θ) at the position, that is, the distance R may be expressed by the below Equation 2, as only an example.

$$p ( r , θ ) = {\int }_{ }^{ } \frac{q ( x )}{R} {e}^{j kR} d x \approx \frac{A}{r} {e}^{j kr} {\int }_{- L / 2}^{L / 2} q ( x ) {e}^{- j k si n θ x} d x \qquad Equation 2$$

Here, q(x) denotes a control signal of the transducer disposed at the distance x, k denotes a wavelength, A denotes an amplitude, and L denotes an aperture size of the array.

The sound pressure P(r, θ) in Equation 2 may be briefly expressed by a function consisting of only a distance and a direction, as in the below Equation 3, as only an example.

$$p ( r , θ ) ∝ \frac{b ( θ )}{r} \qquad Equation 3$$

Here, in Equation 3,

$$b ( θ ) = {\int }_{- L / 2}^{L / 2} q ( x ) {e}^{- j k si n θ x} d x .$$

Accordingly, the sound beam may have the same pattern as a finite Fourier transform (FFT) control signal q(x) of the transducer.

As the aperture size L of the array decreases, the FFT result has a wider distribution, accordingly increasing a width of the sound beam. For example, when all transducers are equally excited, the beam pattern b(θ) may be expressed according to the below Equation 4, as only an example.

$$b ( θ ) = L \frac{sin ( kL sin θ / 2 )}{j kL sin θ / 2} = - j L sin c ( kL sin θ / 2 ) \qquad Equation 4$$

That is, the beam pattern b(θ) may be widened inversely proportional to the aperture size L, according to a sine function that has the maximum value in a vertical direction of the array.

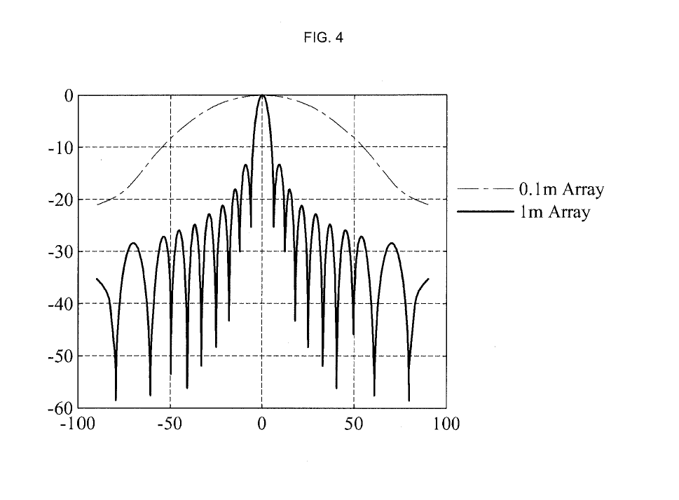

In FIG. 2, when a time delay is properly applied to elements of the respective arrays, the sound beam may be generated parallel to an arrangement direction of the array as shown in FIG. 3. In the embodiment of FIG. 2, the sound beam may not have a symmetrical form. When the time delay is properly applied to the elements of the respective arrays, however, only a wide sound beam may be generated due to restriction in the aperture size as in the broadside beam. The broadside beam will be explained with reference to FIG. 4.

FIG. 4 illustrates a result of comparing beam widths according to aperture sizes of the array being uniformly excited. FIG. 4 shows the beam pattern of the array when the aperture size L is 1 meter (m) and 0.1 m.

As described with reference to FIGS. 2 and 3, the delay and sum structure uses the time delay to apply a spatial window to the respective sound transducers or to compensate for a difference in the distances R between the listener and the respective sound transducers.

The beam pattern of the delay and sum structure may have an almost constant phase although the sound sources are compactly arranged. In addition, according to the FFT, the beam pattern is subordinate mostly to the aperture size in any case.

For example, in a case where a sound beam is uniformly excited according to Equation 4, when a beam width of a main lobe is defined to a position of a first null, an angle θ satisfying kL sinθ=2π, that is, the angle

$$θ = a sin \frac{λ}{L}$$

becomes a half of a width of the main lobe.

As described in the foregoing, the broadside beam refers to the sound beam extending perpendicularly to the arrangement direction of the array, for example. In Equation 4, the sound beam satisfies b(θ)=b(π−θ), and has a symmetrical structure between a front and a back.

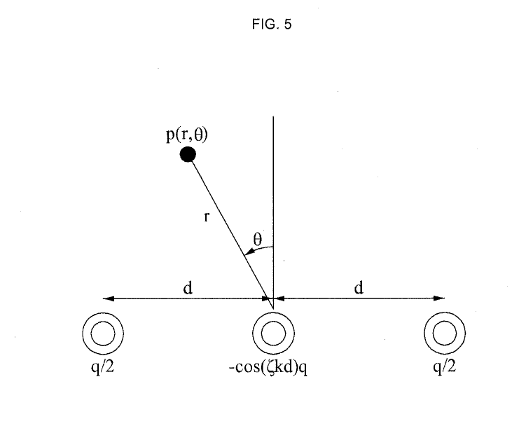

FIG. 5 illustrates a method for solving the problem of a broadside sound source array, according to one or more embodiments.

First, a method for generating a sound beam having a higher directivity than the delay and sum method by arranging the transducers in a broadside direction will be further explained.

When a broadside sound beam is generated using three sound sources arranged as shown in FIG. 5, the control signals q input with reverse or opposing phases for neighboring transducers may be expressed by the below Equation 5, as only an example. Here, though the opposing phases may be represented by a two phases with exactly 180 degree differences, or with opposite signs, embodiments of the opposing phases are not strictly limited to the same.

$$q = [ \begin{matrix}1 / 2 & - cos ( ζ kd ) & 1 / 2\end{matrix} ] ( 0 < ζ kd << \frac{π}{2} ) \qquad Equation 5$$

In addition, the sound pressure p(θ) generated by the control signals q may be expressed by the below Equation 6, as only an example.

$$p ( θ ) = \frac{{e}^{- j kr}}{r} [ cos ( kd sin θ ) + cos ( ζ kd ) ] \approx \frac{{e}^{- j kr}}{r} \frac{{( kd )}^{2}}{2} [ {ζ}^{2} - {sin}^{2} θ ] \qquad Equation 6$$

Here, in Equation 6, the sound pressure p(θ) has a directivity of 2 according to the angle θ. For example, when ζ=1, the sound pressure p(θ) may have the directivity of cos² θ.

The above-described effect of the broadside sound source array may also be obtained by using at least three sound sources. Although, an increase in a number of the sound sources may be undesirable, such a case may be included in various embodiments.

When the number of used sound sources increases, the control signals q may be expressed by the below Equation 7, as only an example.

q′=q*h Equation 7

Here, h denotes a certain window function. When the window function h having an n-number of coefficients is convoluted with the control signals q, a general equation of a control function with respect to an n+2 number of sound sources may be obtained.

For example, a control function q′ in a case of using a uniform window having 2 coefficients may be expressed by the below Equation 8, as only an example.

$$\begin{matrix}{q}^{′} = q * h \\ = [ \begin{matrix}1 / 2 & - cos ( ζ kd ) & 1 / 2\end{matrix} ] * [ \begin{matrix}1 & 1 ]\end{matrix} \\ = [ \begin{matrix}1 / 2 & 1 / 2 - cos ( ζ kd ) & 1 / 2 - cos ( ζ kd ) & 1 / 2\end{matrix} ]\end{matrix} \qquad Equation 8$$

According to the one or more embodiments, the array is arranged perpendicularly to a forward direction, e.g., of the listener, and the sound pressure is generated such that the phases are opposing. As a result, the directivity may be increased.

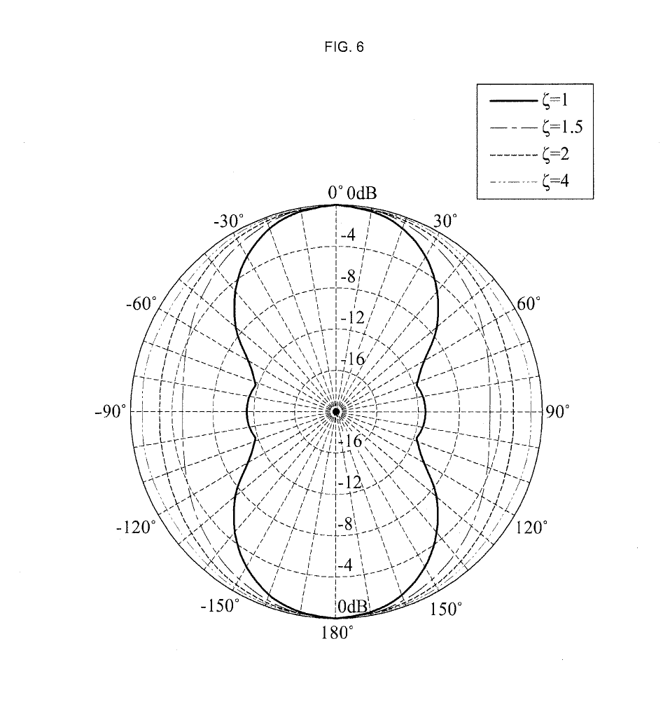

FIG. 6 illustrates variations of a broadside beam pattern according to variation of a parameter, according to one or more embodiments.

Referring to FIG. 6, directivity of a sound beam pattern increases according to variation of a parameter ζ. Here, the directivity is maximized near ζ=1.

The directivity may be highly increased in a horizontal direction by the method explained with reference to FIG. 5. However, in this case, the sound beam pattern becomes symmetrical (p(θ)=p(π−θ)) between the front and the back due to characteristics of a broadside array.

Therefore, one or more embodiments may effectively remove or minimize the rear radiation sound by combining characteristics of the end-fire array and the broadside array, while improving the directivity to the front.

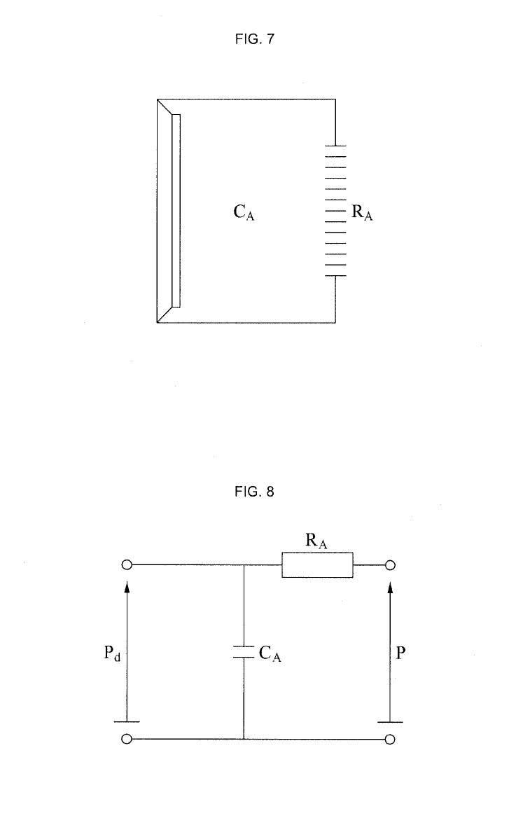

FIG. 7 illustrates a physical structure of a phase-shift loudspeaker, according to one or more embodiments. FIG. 8 illustrates an equivalent circuit model of the phase-shift loudspeaker, according to one or more embodiments. Here, the phase-shift loudspeaker may involve the same meaning as the phase-shift driver.

Referring to the equivalent circuit model shown in FIG. 8, the phase-shift loudspeaker may include three elements, that is, a cabinet which means an acoustical compliance C_{A} (modeled as an acoustical capacitance), a resistance R_{A} of a rear port, and an acoustical inertance or acoustical mass of the rear port. Accordingly, in FIG. 8, references to P and Pd represent modeling of path distances.

A phase shift φ in a low frequency relates to an acoustic resistance as expressed by the below Equation 9, as only an example.

φ=ωC_{A}Rₐ Equation 9

Here, φ denotes a phase difference generated due to a time delay caused by the acoustical compliance C_{A}, that is, an inner space of a speaker, and the resistance R_{A} of the rear port. In addition, ω denotes a measured frequency in a corresponding environment.

The above Equation 9 may be expressed by the time delay τ as shown in the below Equation 10, as only an example.

τ=C_{A}R_{A} Equation 10

Also, the above Equation 9 may be expressed using a difference h of an acoustic equivalent path length between a front diaphragm and a rear opening radiation, as expressed by the below Equation 11, as only an example.

h=c₀C_{A}R_{A} Equation 11

Here, in Equation 11, c₀ denotes a speed of sound.

The acoustical compliance C_{A} may be expressed by the below Equation 12, as only an example.

$${C}_{A} = \frac{V}{{ρ}_{0} {c}_{0}^{2}} \qquad Equation 12$$

Here, V denotes a volume of an enclosure, that is, a speaker space and p₀ denotes an air density of the inner space of the speaker.

Therefore, when the above Equation 12 is applied to the above Equation 11, the acoustic equivalent path length h may be expressed by the below Equation 13, as only an example.

$$h = \frac{V}{{ρ}_{0} {c}_{0}} {R}_{A} \qquad Equation 13$$

It may be understood from the above Equation 13 that the acoustic equivalent path length h may be varied by adjusting the volume of the speaker space or the resistance at the rear opening.

A total pressure field radiated from the phase-shift loudspeaker is partially subject to an amplitude of a sound radiated from the rear port.

When acoustical parameters of the phase-shift loudspeaker are properly selected, the phase-shift loudspeaker may not be influenced by a degree of the pressure radiated from a rear side. Accordingly, the degree of the pressure radiated by the front diaphragm may be equivalent to the degree of the pressure radiated by the rear port.

Under such a presumption, a complex volume velocity radiated by the rear port may be expressed by the below Equation 14, as only an example.

qᵣ=−q_{d}e^{-jkh} Equation 14

Here, in Equation 14, phase-inversion drawn up from the operation of the phase-shift loudspeaker may be expressed by a negative sine wave, representing an example of the aforementioned reverse signed phase, e.g., as a reverse of a positive sign wave. In addition, here, e^{-jkh} denotes a phase shift induced by the resistance and the acoustical compliance.

According to far-field estimation, a resultant far-field pressure may be expressed by the below Equation 15, as only an example.

p=p_{d}[1−e^{-jk(1cos θ+h)}] Equation 15

When the equivalent path length is relatively shorter than the wavelength, as shown in the below Equation 16, as only an example, an index term of the above Equation 15 may be expressed by the below Equation 17, also as only an example.

$$\begin{matrix}k ( l cos θ + h ) = 2 π \frac{l cos θ + h}{λ} < 1 & Equation 16 \\ {e}^{- j k ( l co s θ + h )} \approx 1 - j k ( l cos θ + h ) & Equation 17\end{matrix}$$

As a result, the total pressure radiated from the phase-shift loudspeaker, that is, the sound pressure p may be approximated as shown in the below Equation 18, as only an example.

p≈jkp_{d}(1 cos θ+h)≈jklp_{d}(cos θ+μ) Equation 18

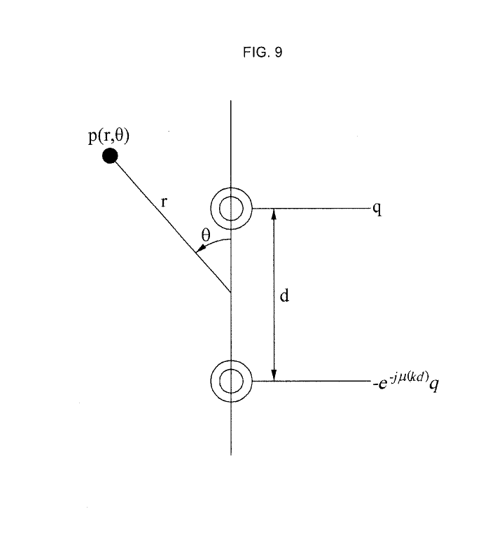

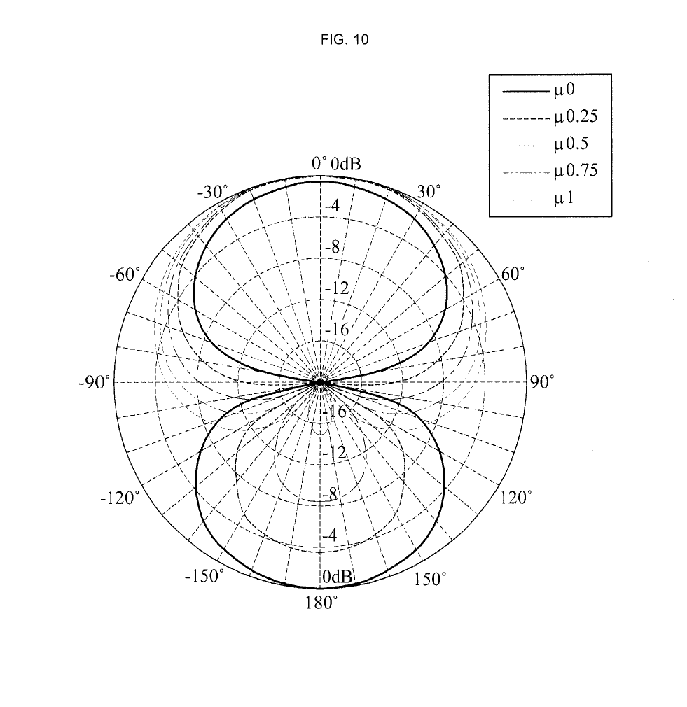

FIG. 9 illustrates a method for solving a problem related to arrangement of a first order end-fire sound source, according to one or more embodiments. FIG. 10 illustrates variations of a beam pattern with respect to a parameter (μ) in the first order end-fire as shown in FIG. 9.

According to Equation 18, a sound field may be a sum of a monopole term and a dipole term. In this instance, t weight of the monopole term is varied depending on the parameter (μ), accordingly varying the directivity.

Referring to FIG. 10, the end-fire beam pattern may effectively remove rear radiation by varying the parameter (μ). However, since the sound beam is generated perpendicularly, for example, to the array according to the end-fire method, the transducers may be arranged linearly and connected to the array according to the method illustrated by Equation 5.

Thus, according to the one or more embodiments, the rear radiation may be removed effectively by combining characteristics of the broadside array and the phase-shift drivers.

FIG. 11 illustrates a beam pattern generated by a personal sound zone creating method, according to one or more embodiments. As mentioned above, the phase-shift loudspeaker may stably achieve end-fire directivity.

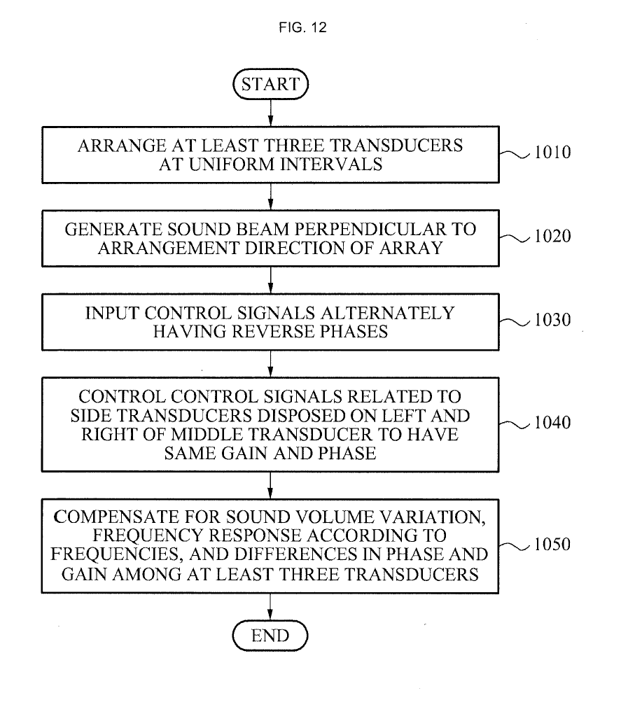

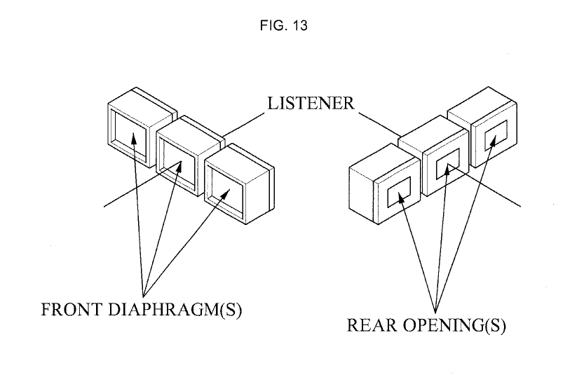

FIG. 12 illustrates a method of creating a personal sound zone, according to one or more embodiments. A personal sound zone creating apparatus (hereinafter, referred to briefly as ‘creating apparatus’), according to one or more embodiments, may arrange at least three transducers at uniform intervals in operation 1010. An order of determining the intervals of the at least three transducers is not limited to embodiments described herein. That is, the intervals may be determined after operation 1030 is performed.

Next, the creating apparatus may generate a sound beam perpendicularly, for example, to an arrangement direction of an array, using at least three transducers included in the array, so as to form a personal sound zone in a position of a listener in operation 1020.

Here, each of the at least three transducers may be a phase-shift driver or a phase-shift loudspeaker adapted to reduce rear radiation occurring from each of the at least three transducers by controlling an open port directed opposite to a forward direction, e.g., toward a listener, and an acoustic resistance generated in a rearward direction relative to the respective transducer and the forward direction.

As mentioned above, the acoustic resistance may be generated by attaching a sheet of metal gauze in the rearward direction from the at least three transducers.

The creating apparatus may alternate input of control signals having opposing phases to the at least three transducers, respectively, in operation 1030.

The creating apparatus may control the control signals such that side control signals related to side transducers disposed on the left side and the right side of a middle transducer of the at least three transducers having the same gain and the same phase as each other, in operation 1040.

In addition, the creating apparatus may input the control signals such that a control signal related to the middle transducer has a different gain from that of control signals related to the side transducers.

The creating apparatus may compensate for sound volume variation and a frequency response according to frequencies, caused by irregular responses of the phase shift driver, and compensate for differences in a phase and a gain among the at least three transducers, in operation 1050.

FIG. 13 illustrates a diagram showing an array, according to one or more embodiments.

Referring to FIG. 13, the array for generating a broadside beam may include three transducers arranged orthogonal to a forward sound generation direction, e.g., toward a listener. Simultaneously, the end-fire beam may provide directivity to the listener using a phase-shift driver as the transducers of an array as described above.

In a structure of the array, the sound pressure p(θ) generated according to the above Equation 18 may be expressed as a product of two sound beam patterns as shown in the below Equation 19, as only an example.

$$p ( θ ) \approx \frac{j ( kl ) {( kd )}^{2} {e}^{- j kr}}{2 r} ( {ζ}^{2} - {sin}^{2} θ ) ( μ + cos θ ) \qquad Equation 19$$

The sound beam pattern according to Equation 19 minimizes rear radiation of sound, e.g., by not causing the rear radiation, by generating directivity (μ+cos θ) while generating a sharp directivity forward by the broadside array.

A control signal related to a middle transducer disposed in the middle of the array may have a different gain from control signals related to side transducers disposed on the left side and the right side of the middle transducer. The control signals related to the side transducers may have the same gain and the same phase as each other.

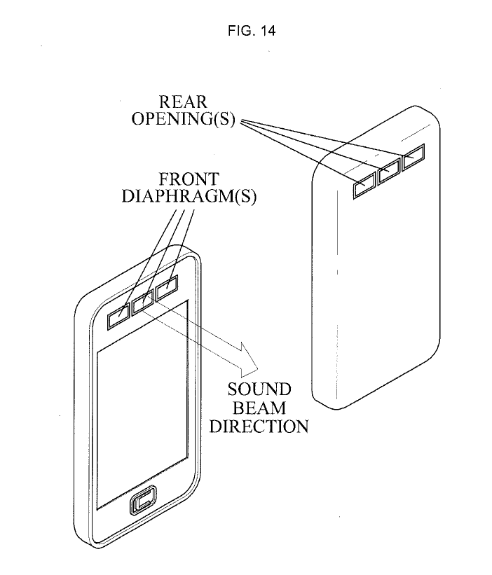

FIG. 14 illustrates a personal audio electronic device, according to one or more embodiments. The personal audio electronic device includes an array, according to one or more of the other described embodiments described herein.

Referring to FIG. 14, an array unit generates a sound beam having directivity according to input of a control signal including multi-channels. The array unit may include at least three transducers.

The array unit may be configured such that a loudspeaker disposed on a front side and a rear port of a phase-shift structure disposed in on a back side are directed opposite from each other as shown in FIG. 14.

Referring to FIG. 14, directivity in a horizontal direction may be enhanced by a broadside array configured to generate a sound beam orthogonal, for example, to the arrangement direction of one array, that is, the arrangement of the at least three transducers, in the personal audio electronic device. In addition, the rear radiation may be controlled by forming an end-fire beam by radiation from rear ports of phase-shift drivers.

Each of the at least three transducers may include a cavity of a loudspeaker, that is, an open port directed opposite to a forward direction, e.g., toward the listener. Also, each of the at least three transducers may include an acoustic resistance including a sheet of metal gauze, for example, attached in a rearward direction relative to the respective transducer and the forward direction. The acoustic resistance may be controlled to reduce rear radiation generated from each of the at least three transducers, that is, to generate end-fire directivity.

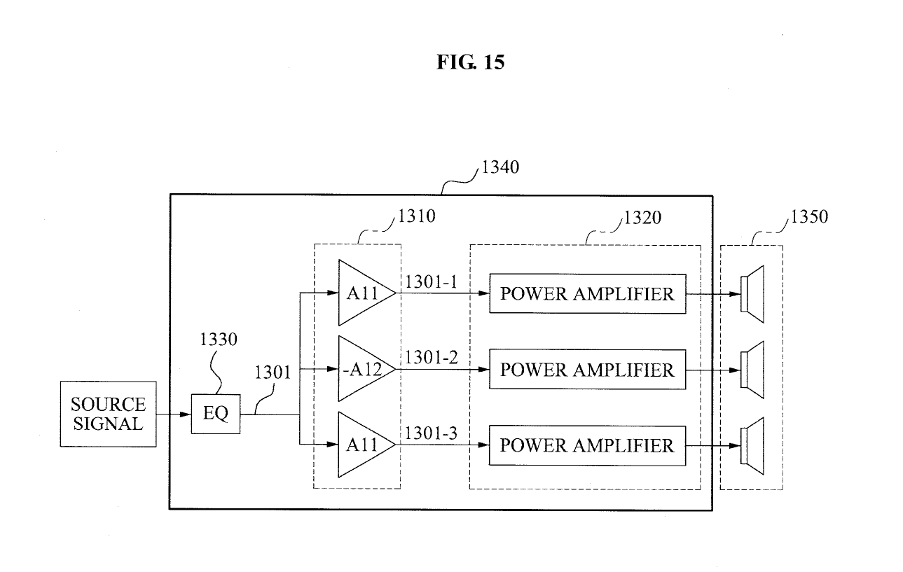

FIG. 15 illustrates signal processing procedures in a personal sound zone creating apparatus, according to a personal audio electronic device embodiments.

Referring to FIG. 15, the personal sound zone creating apparatus may include a control signal generation unit 1340 and an array unit 1350. The control signal generation unit 1340 may include a multichannel filter 1310 and a multichannel power amplifier 1320.

The array unit 1350 may include at least three transducers, that is, phase-shift transducers. Each of the at least three transducers may be a phase-shift driver adapted to reduce rear radiation occurring from each of the at least three transducers by controlling an open port directed opposite to a forward direction, e.g., toward a listener, and an acoustic resistance generated in a rearward direction relative to the respective transducer and the forward direction.

The control signal generation unit 1340 may further include an equalizer EQ 1330 adapted to compensate for sound volume variation and a frequency response according to frequencies, the sound volume variation and the frequency response caused by use of the phase-shift driver.

The control signal generation unit 1340 may generate control signals appropriate for the arrangement of the array unit 1350, according to the a personal audio electronic device embodiments. The control signals may have characteristics as follows.

The control signals for generating high directivity may be divided into control signals 1301-1, 1301-2, and 1301-3 for exciting the array unit 1350.

The respective control signals 1301-1, 1301-2, and 1301-3 may include signals of three channels for generating a sound beam orthogonal, for example, to the arrangement direction of the at least three transducers by controlling the at least three transducers constituting the array unit 1350.

A signal A12 for controlling a middle transducer disposed in the middle of the array unit 1350 may have a reverse or opposing phase, with respect to signals A11 for controlling the other transducers, as referenced in Equation 5. Similar to the notation above, though opposing phases described herein may have opposite signs, embodiments are not limited to the same.

Here, the signals A11 for controlling the other transducers disposed on the left side and the right side of the middle transducer in the array unit 1350 may have the same sign.

In the control signals generated by the control signal generation unit 1340, directivity in each frequency may be controlled by an optimization technology.

For example, in the array unit 1350, the at least three transducers operate in each frequency to maximize an acoustic contrast of mean square pressures between a dark zone in every position and a bright zone at a head of the listener.

In addition, since the sound beam is generated orthogonal, for example, to the arrangement direction of the array unit 1350, a required number of transducers in a thickness direction may be reduced.

Furthermore, here, since the end-fire array may be formed toward the listener, rear radiation of the sound may be effectively reduced or minimized while directivity is increased toward the listener.

According to one or more embodiments of a personal audio device, since the input control signals have reverse or opposing phases with respect to the at least three transducers included in the array, a sound may be effectively focused on a select sound zone even with a small-size array.

In addition, according to one or more embodiments, since the sound beam generated may be orthogonal to the arrangement direction of the array, the number of transducers necessary in a thickness direction may be reduced. As a result, the personal audio device formed may be slimmer.

Moreover, according to one or more embodiments, since the end-fire array is formed in a forward direction, e.g., toward the listener, back radiation of the sound may be effectively reduced or minimized while directivity may be increased toward the listener.

In one or more embodiments, one or more personal electronic apparatus or device descriptions herein include one or more hardware devices and/or hardware processing elements/devices. For example, in an addition to described transducers, in one or more embodiments, any described electronic apparatus or device may further include one or more desirable memories, and any desired hardware input/output transmission devices, as only examples. In one or more embodiments, any described electronic apparatus or device may further use such one or more hardware devices and/or hardware processing elements/devices to reproduce audio data and provide the reproduced audio data to one or more transducers discussed herein. Further, the term apparatus should be considered synonymous with elements of a physical system, not limited to a device, i.e., a single device at a single location, or enclosure, or limited to all described elements being embodied in single respective element/device or enclosures in all embodiments, but rather, depending on embodiment, is open to being embodied together or separately in differing devices or enclosures and/or differing locations through differing hardware elements.

In addition to the above described embodiments, embodiments may also be implemented through computer readable code/instructions in/on a non-transitory medium, e.g., a computer readable medium, to control at least one processing element/device, such as a processor, computing device, computer, or computer system with peripherals, to implement any above described embodiment or aspect of an embodiment. The medium can correspond to any defined, measurable, and tangible structure permitting the storing and/or transmission of the computer readable code. Additionally, one or more of the electronic apparatus or devices described herein may include the at least one processing element or device.

The media may also include, e.g., in combination with the computer readable code, data files, data structures, and the like. One or more embodiments of computer-readable media include magnetic media such as hard disks, floppy disks, and magnetic tape; optical media such as CD ROM disks and DVDs; magneto-optical media such as optical disks; and hardware devices that are specially configured to store and/or perform program instructions, such as read-only memory (ROM), random access memory (RAM), flash memory, and the at least one processing device, respectively. Computer readable code may include both machine code, such as produced by a compiler, and files containing higher level code that may be executed by the computer using an interpreter, for example. The media may also be any defined, measurable, and tangible elements of one or more distributed networks, so that the computer readable code is stored and/or executed in a distributed fashion. In one or more embodiments, such distributed networks do not require the computer readable code to be stored at a same location, e.g., the computer readable code or portions of the same may be stored remotely, either stored remotely at a single location, potentially on a single medium, or stored in a distributed manner, such as in a cloud based manner. Still further, as noted and only as an example, the processing element could include a processor or a computer processor, and processing elements may be distributed and/or included in a single device. There may be more than one processing element and/or processing elements with plural distinct processing elements, e.g., a processor with plural cores, in which case one or more embodiments would include hardware and/or coding to enable single or plural core synchronous or asynchronous operation.

The computer-readable media may also be embodied in at least one application specific integrated circuit (ASIC), Field Programmable Gate Array (FPGA), or non-processor hardware, as only examples, which execute (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

What is claimed is:

1. An apparatus creating a personal sound zone, the apparatus comprising:
an array unit configured to include at least three transducers arranged orthogonal to a sound beam generation direction, the at least three transducers including at least one a respective port opened in opposite to the sound beam generation direction; and
a control signal generation unit configured to generate control signals, including opposing phases, related to the array unit so that the array unit forms a sound beam, toward a listener, in the sound beam generation direction.

2. The apparatus of claim 1, wherein each of the at least three transducers comprises a phase-shift driver mounted in-line with the sound beam generation direction and configured to generate the sound directivity in the sound beam generation direction using a method of minimizing rear radiation occurring from each of the at least three transducers by generating an acoustic resistance in a direction different from the sound beam generation direction.

3. The apparatus of claim 2, wherein the control signal generation unit further comprises an equalizer configured to compensate for sound volume variation and frequency response according to different frequencies, caused by irregular responses of the respective phase-shift drivers, and to compensate for differences in phases and gains respectively among the at least three transducers.

4. The apparatus of claim 1, wherein intervals among the at least three transducers are in-line and uniform.

5. The apparatus of claim 1, wherein the control signal generation unit generates control signals such that a control signal related to a middle transducer among the at least three transducers has a different gain from control signals related to side transducers respectively disposed on a left side and a right side of the middle transducers.

6. The apparatus of claim 1, wherein the control signal generation unit controls control signals such that control signals related to side transducers respectively disposed on the left side and the right side of a middle transducer among the at least three transducers have a same gain and a same phase as each other.

7. A method of creating a personal sound zone, the method comprising:
generating a sound beam, toward a listener, orthogonal to an arrangement of at least three transducers of an array, to form the personal sound zone in a sound beam generation direction; and
applying control signals to the at least three transducers included in the array so that adjacent transducers are applied control signals having opposing phases.

8. The method of claim 7, wherein the at least three transducers include at least one respective port opened in opposite to the sound beam generation direction, and the method further comprises minimizing rear radiation through the at least one respective port corresponding to the generated sound beam based on the applied control signals having the opposing phases.

9. The method of claim 7, wherein each of the at least three transducers comprises a phase-shift driver that is mounted in-line with the sound beam generation direction and configured to generate the directivity in the direction toward the listener using a method of minimizing rear radiation occurring from each of the at least three transducers by generating an acoustic resistance from each of the at least three transducers in a direction different from the sound beam generation direction.

10. The method of claim 9, further comprising compensating for sound volume variation and a frequency response according to different frequencies, caused by irregular responses of the respective phase shift drivers, and also compensating for differences in phases and gains among the at least three transducers.

11. The method of claim 7, further comprising arranging the at least three transducers at uniform in-line intervals in the array.

12. The method of claim 7, further comprising controlling the control signals such that a control signal related to a middle transducer disposed in the middle among the at least three transducers has a different gain from control signals related to side transducers respectively disposed on a left side and a right side of the middle transducer.

13. The method of claim 7, further comprising controlling the control signals such that control signals related to side transducers respectively disposed on the left side and the right side of a middle transducer disposed in the middle among the at least three transducers having a same gain and a same phase as each other.

14. A non-transitory computer readable recording medium comprising computer readable code to control at least one processing device to implement the method of claim 7.
